(19) United States
(12) Patent Application Publication
(10) Pub. No.: US 2025/0149702 A1
(43) Pub. Date: May 8, 2025

(54) BATTERY HOLDER

(71) Applicant: BB IPR Limited, Stanmore, Middlesex (GB)

(72) Inventor: Stephen Paul Tollman, St Albans, Hertfordshire (GB)

(21) Appl. No.: 18/838,032

(22) PCT Filed: Feb. 7, 2023
(86) PCT No.: PCT/GB2023/050268

§ 371 Date: Aug. 13, 2024

(30) Foreign Application Priority Data
Feb. 14, 2022 (GB) 2201880.8
Nov. 23, 2022 (GB) 2217493.2

(51) Int. Cl. H01M 50/216; H01M 50/264; H01M 50/269; H01M 50/271

(52) U.S. Cl. CPC H01M 50/216; H01M 50/264; H01M 50/269; H01M 50/271

(57) ABSTRACT

A battery holder includes a tubular sleeve defining a longitudinal inner passage having a longitudinal axis and dimensioned to retain a plurality of batteries in a single linear array. In one embodiment it is necessary to insert a spent battery at a first end of the sleeve in order to eject a new battery from a second end of the sleeve and the holder has a barrier extending across the second end of the sleeve, to prevent a battery being pushed out of the holder in the direction of the longitudinal axis, the barrier being arranged to retain the battery in a holding space at the second end of the sleeve, from where it may be pushed out of the holder through a first opening in the sleeve. The battery holder provides for a more secure containment of batteries.

The present invention relates to a battery holder suitable for securely packaging at point of sale, storing and dispensing one or more new batteries and/or for receiving a spent battery or batteries, for disposal or otherwise. The holder may be suitable for use with batteries commonly called button batteries, such as the common sizes, or types, 2032, 2025 and 2016, the most hazardous sizes to young children, and larger and smaller types of button batteries. These now find many applications in household devices, such as in items like calculators, audio devices in children's toys and books, watches, hearing aids, scales and similar, powered by button batteries. However, the invention is also applicable to battery holders for some other types of batteries, particularly cylindrical batteries such as AA and AAA batteries.

With the use of the above-mentioned types of batteries becoming ever increasingly widespread, there are particular concerns commencing from the purchase stage, regarding the secure storage of new batteries and spent batteries by the consumer through the lifecycle of the batteries to the safe disposal of such batteries, particularly the button batteries, as a considerable number of these are accidentally swallowed each year by both children and pets. In addition to the potential choking hazard, there is also the risk of internal burning from these types of batteries, either by chemical or electrical discharge from a battery. This requires emergency surgical removal for otherwise it can result in lifelong injury or even death.

To partly address the above issues, button batteries in devices are now sometimes secured in place, particularly in the case of children's toys, by means of a screw on cover, which normally prevents access by small children, who are most prone to swallowing such batteries.

Also directed to the above problem is the battery holder disclosed in International Patent Application, Publication Number WO 2020/232497 A1. The battery holder disclosed in this document provides for the secure packaging at point of sale, for secure storage prior to use and the dispensing of new batteries and to the secure storage and disposal of spent batteries. The battery holder may be sold on its own to insert spent batteries, or new batteries purchased in blister packs, or the holder may be purchased with a preloaded number of new batteries stored within, each of which is dispensed from a second end by insertion of a spent battery at a first end, opposite to the first end. A significant benefit of this arrangement is that it ensures spent batteries are safely stored, for it normally requires a spent battery, removed from a device, to be inserted into the battery holder, in order to expel from the holder a new replacement battery to be used in the device.

The present invention aims to provide an improved battery holder.

According to a first aspect of the present invention there is provided a battery holder comprising a sleeve defining a longitudinal inner passage having a longitudinal axis and having a generally rectangular and generally uniform cross section along its length, wherein: the sleeve comprises a first major face, or parts thereof, opposed to a second major face and a first minor face opposed to a second minor face, with the respective pairs of opposed faces being arranged such as to, in use, maintain batteries, of a size the holder is intended to accommodate, within the sleeve in a single linear array and to prevent the batteries riding over each other within the sleeve; the sleeve has a first end open to receive a battery; the sleeve has a second end, opposite to the first end, the second end of the sleeve having a barrier, or partial barrier, across the second end of the sleeve to prevent batteries being pushed out of the holder in the direction of the longitudinal axis; the second end of the sleeve has a barrier or partial barrier across the end of the sleeve, to prevent batteries being pushed out of the holder in the direction of the longitudinal axis; the barrier, or partial barrier, together with at least two opposed faces of the sleeve are arranged to retain a battery in a holding space in the sleeve at the second end of the sleeve; a first opening dimensioned to permit a battery in the holding space to be pushed through it, with the a second opening opposed to the first opening, or a region opposed to the first opening, being arranged to permit a user to apply pressure to the battery, in order to push the battery from the holding space so that it either extends out of the first opening in the holder, to a position where it may be pulled out of the holder, or where the battery is pushed totally out of the battery holder through the first opening.

A battery holder in accordance with the first aspect of the present invention has all the advantages mentioned above, in respect of the battery holder disclosed in WO 2020/232497 A1. However, the battery holder of the present invention provides the additional feature of having a barrier, or partial barrier, across the end of the sleeve of the battery holder, which permits the battery holder to effectively catch a battery ejected from the passage of the battery holder and to then hold the battery in a holding space until a user subsequently pushes their finger or thumb, for example, through a second opening, or applies pressure on the second opening region, which may be in the form of a flexible membrane or deflectable portion, in order to force the battery downwards, causing the battery to be displaced so that a front end of the battery then protrudes below the level of the bottom face of the holder, enabling the battery to then be pulled out of the battery holder by the finger and thumb of a user's other hand. Alternatively, the holder could be arranged to permit the battery to be pushed, in one movement, completely out of the battery holder through the first opening. Where a second opening is provided then this may be dimensioned so that a battery may not pass through the second opening.

A battery holder in accordance with the first aspect of the present invention offers significant advantages over known battery holders, for it requires at least two separate and distinct actions to be performed to obtain a new battery from the battery holder. These two distinct actions are unlikely to be performed by a baby or young child, who are most at risk from loose batteries.

One advantage of the requirement for at least two separate actions is that it first prevents, or at least significantly decreases, the likelihood that a baby or small child, playing with the holder, will somehow randomly release a battery from the holder. This also applies to a slightly older or more inquisitive baby or small child, who can see the shiny battery inside and who deliberately tries to remove it, for here batteries at the dispensing end are substantially obscured by the barrier. The barrier also prevents access to a new battery and prevents an item being easily pushed into the passage from the second end to push a battery or batteries backwards along the passage and out the first end of the passage.

The more exposed first end of the battery holder, for receipt of a spent battery, is more easily secured by means of a one way mechanism, that will only let batteries pass into the battery holder. Furthermore, any thin object poked into the passage of the battery holder, through the opening at the first end for receiving spent batteries, may cause the batteries to be pushed along inside the holder, but this alone cannot cause a battery to be dispensed from the holder.

In addition to the above, the provision of the barrier, or partial barrier, also makes it far less likely that a battery will be accidentally released from the holder when, for example, it is dropped onto a hard surface or vigorously shaken. This is because, if the battery holder should be dropped or shaken in such a manner as to cause a battery to be ejected from the passage of the sleeve at the second end, the battery would then likely be captured by the barrier and retained in the holding space. It is far less likely that the action of dropping or shaking the battery holder would cause a battery to first travel in a first direction, required to exit the passage of the sleeve into the holding space, and to then travel in a second direction, orthogonal to the first direction, as necessary for the battery to then exit from the holding space through the first opening, which requires the battery to be depressed whilst in the holding space.

In addition to the barrier feature providing additional security against the above-mentioned release of a battery, by a baby or small child or by accidental release due to the battery holder being dropped. The provision of a barrier and holding space provides a battery holder that is more convenient to use. This is particularly the case where, at the first end of the sleeve, the first major face, or parts thereof, terminates short of the second major face, such that the second major face defines an open platform portion on which a battery may be placed and/or aligned with the passage prior to being pushed into the passage. With this feature, in order to insert a spent battery to permit a new battery to be ejected from the battery holder, it is then most convenient to hold the battery holder in one hand while the other hand places the spent battery on the platform at the first end of the battery holder and then pushes the battery along that platform into the passage of the sleeve.

The above process then simultaneously causes a new battery to be ejected from the passage at the second end of the sleeve, which in the absence of the barrier or partial barrier forming a holding space, would have resulted in an ejected battery falling from the holder, which could result in the battery contacting the floor and rolling out of sight under an item of furniture or the like, to be subsequently discovered by a child or pet. Although the likelihood of this is not great for any one battery holder, there are hundreds of thousands of batteries of relevant types being replaced every day and each year many children are killed by such batteries and very many more suffer trauma and distress as a result of swallowing such batteries, particularly where children do not have immediate access to appropriate medical facilities.

The provision of the barrier across the end of the passage of a battery holder, in accordance with the first aspect of the present invention, permits a user to use one hand to hold the holder while the other pushes a spent battery into the passage of the sleeve, to eject a new battery. The new battery will then be automatically captured by the barrier and held in the holding space, enabling the user to then, in a second and separate action, to hold the battery holder in one hand and, press the battery out of the holding space, partway through the first opening of the battery holder, from where it may then be pulled out of the holder simultaneously by the other hand, or alternatively it may be pressed all the way out into the palm or fingers of the other hand. In either case the battery being held in the holding space greatly reduces the likelihood of the battery being dropped.

The barrier, or partial barrier, may preferably be formed by the opposed faces of the sleeve, more preferably two opposed minor faces, extending inwardly at the second end of the sleeve and these may extend inwardly and join to define a barrier in the form of a closed loop at the end of the sleeve. This is advantageous for the barrier may then match the curved shape of a button battery and thus wrap around a battery in the holding space, to assist in retaining the battery in the holding space.

The opposed faces may define the first opening and also a second opening of the sleeve opposed to the first opening, the second opening being arranged to permit a user to apply pressure to a battery in the holding space in order to push the battery from the holding space, so that it either extends out of the first opening in the holder, to a position where it may be pulled out of the holder, or where the battery is pushed totally out of the battery holder through the first opening.

Preferably, the second opening is dimensioned to prevent a battery, of a size the holder is intended to accommodate, passing through the second opening, thus preventing the second opening being a further potential point from which a battery may be withdrawn from the holder.

In embodiments where the sleeve has a second opening, opposed to the first opening, with the second opening being arranged to permit a user to apply pressure to a battery in the holding space, the battery holder may further comprise a cover arranged to be retained over, or in, the second opening, to prevent a user from applying pressure to a battery in the holding space and to thus prevent a user pushing the battery from the holding space. This is advantageous in that it provides a “lock” function, requiring the cover to be first opened before a battery can be presented for removal from the holding space, or pressed out of the holding space.

Preferably the battery holder comprises at least two clips arranged to retain the cover in place over, or in, the second opening, wherein the two clips are arranged so that they must be released simultaneously to permit the cover to be opened from the second opening. This requirement, for simultaneous release of the two clips, is very difficult for babies or small children to achieve and therefore the provision of two clips can effectively provide a lock that prevents very young children from opening the cover and then having the opportunity of potentially releasing a battery from the holding space.

More preferably the battery holder comprises at least three clips arranged to retain the cover in place over, or in, the second opening, whereby the three clips are arranged so that they must be released simultaneously, to permit the cover to be opened from the second opening. This has the same advantage as with the two clips described above, but this arrangement is even harder for small children to release.

The at least two clips may be formed on the cover, integrally with the cover and the cover may be permanently tethered to the sleeve, thus avoiding any small separate parts, which may otherwise present a potential hazard to small children.

The cover may be initially retained over or in the second opening by a tamper evident seal that must be broken or removed before the cover can be opened for the first time from the second opening. The cover may be weakly bonded to the case by adhesive, heat welding or by being mechanically formed integrally with the top portion and weakly joined thereto, to thereby provide a tamper evident seal prior to the cover first being opened. This provides the advantage that batteries within the battery holder, prefilled by the manufacturer, cannot be removed from the battery holder without the tamper evident seal first being broken.

The battery holder preferably comprises a tongue extending from the major face adjacent the first opening, partway across the first opening to partly obscure the first opening and thus to retain a battery in the holding space, wherein the tongue may be deflected by pressure applied to the battery, forcing the battery in the holding space against the tongue so that the tongue is displaced, permitting the battery to either extend at angle out of the first opening in the holder, to a position where the battery may be pulled out of the holder, or to be pushed totally out of the battery holder through the first opening. The provision of the tongue, which may be formed integrally with the sleeve, will prevent a battery being accidentally displaced from the holding space, thus trapping the battery in the holding space until sufficient pressure is exerted on the battery by a user, to sufficiently deflect the tongue to permit the battery to be partly pass at an angle through the first opening or to be ejected through the first opening.

The tongue is preferably dimensioned and arranged to be deflected in a manner to permit the battery to be displaced from the holding space to a position where the battery extends out of the first opening and to a position where it may be pulled out of the holder simultaneously by a user's other hand, requiring the user to exert pressure to the battery against the tongue, at the same time as pulling the battery out of the holder through the first opening. This permits the battery holder to “hand” the battery to the user, permitting the user to then pull the battery from the holder, which further acts to ensure that the battery is not accidentally dropped on removal from the battery holder. Furthermore, as this requires the simultaneous pressing of the battery against the tongue and pulling of the battery through the first opening, these are another two task which is very difficult for babies or small children to simultaneously perform.

Preferably, the sleeve in cross section has a first major face, so that the two major faces and two minor faces define a closed tubular sleeve. However, alternatively, instead of a complete first major face, this could comprise just two edge portions (parts thereof) defining a central slit along what would otherwise be the first major face, to form a generally C-shaped, but generally rectangular, sleeve.

In the case where the sleeve in cross section has a first major face, so that the two major faces and two minor faces define a closed tubular sleeve, the first major face is preferably concave with a central portion extending inwardly to sandwich batteries within the sleeve between the first major face and the second major face. Alternatively, in the case where there are only two edge portion of what would be the first major face, these preferably extend inwardly to sandwich batteries within the sleeve between the inwardly extending edges and the second major face. In either embodiment, such a feature is particularly advantageous where the sleeve is formed of a plastic material and is thus resilient, for the minimum width between said one face, or edges, and the opposed face may be slightly less than the dimension of the battery between the one face or edges and the opposed face, so that the presence of a battery slightly forces the one face or edges apart from the opposed face, so that the one face or edges and opposed face may then frictionally impede the passage of the battery along the whole length of the battery holder.

Preferably, the battery holder further comprises a first protrusion extending into the passage from one of said faces and positioned towards the first end of the sleeve, approximately in line with or slightly inward of the end of the first major face, or parts thereof, so that the first protrusion retains a battery in the passage towards the first end of the sleeve and acts to retain the battery in the passage in a position where it is substantially concealed by the major faces of the sleeve, to prevent a person being able to obtain sufficient purchase on the battery to be able to remove it from the first end of the sleeve. The protrusion may be sufficiently resilient, or resiliently mounted, to permit a battery to be pushed into the sleeve past the protrusion. The protrusion may also have the profile of a tooth of a saw, to assist insertion of a battery but to then provide a vertical barrier opposing subsequent release of the battery from the first end of the sleeve.

Similarly to the above, the battery holder may comprise a second protrusion extending into the passage from one of said faces and positioned towards a second end of the sleeve approximately in line with, or forming an edge of, the first opening, so that the second protrusion acts to retain a battery in the passage towards the second end of the sleeve and acts to prevent it passing into the holding space, thus acting to retain the battery in the sleeve in a position where it cannot be displaced by a finger or thumb pushed into the second opening. It will thus then require a spent battery to first be inserted into the first end of the sleeve to enable its removal. The protrusion should though be sufficiently resilient, or resiliently mounted, to permit a battery to be pushed by an adjacent battery along the sleeve into the holding space. In order to provide resilience to the protrusions, one or each protrusion may be formed on the end of a tongue integrally formed in one of the faces of the sleeve.

Preferably, the battery holder comprises a separator shaped to fit within the passage and to be pushed along the passage between two adjacent batteries. The separator may preferably be dimensioned to frictionally engage with the sleeve. This enables spent batteries inserted at the first end of the sleeve to be separated from new batteries originally supplied in the sleeve. This may be particularly advantageous where the sleeve is clear and the separator is visible through the sleeve, for this enables it to be readily determined how many new batteries remain in the sleeve.

Preferably, the separator, which may be coloured and visible through the case, is shaped so as to be prevented from passing through either the first or second openings when reaching the second end of the sleeve. In this manner, once all the new batteries have been dispensed, the separator will effectively seal the second end of the sleeve and can then be safely recycled complete with the spent batteries enclosed.

The battery holder could be formed by being cut from extruded lengths of sleeve, with subsequent processes applied or components added to form said barrier and other features. However, it is particularly advantageous if the sleeve is formed from two separate halves, or two halves joined by a living hinge, whereby the battery holder can then be formed by injection moulding. The two halves may then be joined together to form the sleeve, either by cooperating mechanical engagement means formed on respective ones of the two halves, which cooperating mechanical engagement means are arranged to lock the two halves together, possibly employing “snap-fit” fastenings along one edge (living hinge embodiment) or both edges. Alternatively, the two halves could be joined by being frictionally or mechanically welded together, by being glued together, or by any other appropriate means known to the skilled person.

In one embodiment, the battery holder may be arranged to hold at least one button battery, of a specific size, wherein the width of the passage between the two minor faces of the sleeve is approximately equal to the diameter of the button battery and the height of the passage between the two major faces, where the major faces meet the minor faces is approximately equal to the depth of the button battery and wherein the first opening is generally circular and has a diameter approximately equal to the diameter of the button battery.

Alternatively, the battery holder may be arranged to hold at least one cylindrical battery of a specific size, wherein the height of the passage between the two major faces of the sleeve, at a point where the two major faces of the sleeve meet the respective minor faces of the sleeve, is approximately equal to the diameter of the cylindrical battery and wherein the width of the passage between the two minor faces is approximately equal to the length of the cylindrical battery.

In the case of a battery holder arranged to hold a cylindrical battery, it is preferable that the separator is shaped to fit in the passage and arranged to be positioned between two adjacent batteries and to pass along the passage between the two adjacent batteries, wherein the separator has on a first side a concave surface arranged to partly accommodate the respective curved side of an adjacent spent battery and on a second side a flat surface arranged to abut an adjacent new battery, the separator having an extended portion arranged to lie alongside the positive terminal (pip) extending from one end of the new battery closest to the second end of the sleeve and to space the remaining end of the battery from the respective face of the sleeve.

The separator may also have a portion extending from the second side of the separator and arranged to limit the travel of the separator by engaging with the barrier. The extended flat surface permits the battery to be pressed out of the holding space without fouling on the separator, while the portion extending from the second side of the separator prevents the separator passing to the holding space and thus form potentially being pressed out of the first opening, or part way out of the first opening.

The battery holder may be arranged to store two or more batteries within the passage to provide convenient storage and dispensing of a plurality of batteries. However, the battery holder could be arranged to store only a single battery, where the holder is dimensioned to provide a less potential chocking hazard than a battery stored within the battery holder. A battery holder for a single battery would still require a spent battery to be inserted to dispense the new battery and would thus provide the advantages associated with this. In addition, the single battery holder, because of its likely small size, may be shaped to have a portion extending from it, arranged to sufficiently enlarge the battery holder to enable it to comply with small parts safety regulations for protecting young children.

According to a second aspect of the present invention, there is provided a battery holder for receiving and storing spent batteries, the battery holder comprising a sleeve defining a longitudinal inner passage having a longitudinal axis and having a generally rectangular and generally uniform cross section along its length, wherein: the sleeve comprises a first major face, or parts thereof, opposed to a second major face and a first minor face opposed to a second minor face, with the opposed faces being arranged to, in use, maintain batteries of a size the holder is intended to accommodate within the sleeve in a single linear array and to prevent the batteries riding over each other within the sleeve; the sleeve has a first end arranged to receive a spent battery; the sleeve has a second closed end; and wherein the battery holder further comprises a first protrusion extending into the passage from one of said faces and positioned towards the first end of the sleeve, approximately in line with or slightly outward of the end of the first major face, or parts thereof, so that the first protrusion will retain a battery in the passage towards the first end of the sleeve and acts to retain the battery in the passage in a position where it is substantially concealed by the major faces of the sleeve, to prevent a person being able to obtain sufficient purchase on the battery to be able to remove it from the first end of the sleeve, the first protrusion being sufficiently resilient, or sufficiently resiliently mounted, to permit a battery to be pushed into the sleeve pasts the first protrusion.

A battery holder, in accordance with the above second aspect of the present invention, provides a safe receptacle into which spent batteries may be inserted and which retains those batteries for safe disposal in a manner which makes it very difficult for babies and/or young children to remove the batteries. Thus, once a spent battery has been inserted into the holder the risk of a child swallowing a battery is removed providing the advantages mentioned above in respect of the first aspect of the present invention. Additionally, by retaining the batteries as a single linear array, the risk of any shorting between adjacent batteries, which may even occur in the case of spent batteries, is also avoided eliminating known fire risks.

The protrusion may be in the form of a stop at the end of a resilient tongue extending into the passage from one face of the sleeve, or it may have the profile of a tooth of a saw, to assist insertion of a battery but to then provide a vertical barrier opposing subsequent release of the battery from the first end of the sleeve.

Preferably, at the first end of the sleeve, the first major face, or parts thereof, terminates short of the second major face, such that the second major face defines an open platform portion on which a battery may be placed and/or aligned with the passage prior to being pushed into the passage.

A battery holder in accordance with either the first or second aspects of the present invention may be arranged to receive different types of button cell batteries all having one specific diameter, but having one of a range of different thicknesses, wherein the inner passage is dimensioned to accommodate all batteries in the range including those having a maximum thickness within said range of thicknesses, wherein one of the major faces of the sleeve has a plurality of spaced apart tongues, each resiliently biased such that the spaced apart tongue projects into the longitudinal inner passage and acts to retain any battery therein, having a thickness within said range less than the maximum thickness, against the opposed major face of the sleeve defining the longitudinal inner passage.

An advantage of the above arrangement is that, in the case of a battery holder for the dispensing of batteries, a single type of battery holder may be used to hold batteries of different types, having the same diameter but having different thicknesses, for example button battery types 2016, 2025 and 2032, which all have the same diameter but have different thickness. This enables batteries of a first thickness to be packaged in a battery holder having specific dimensions and batteries of a second thickness or third thickness to be packaged in that same holder, permitting a battery supplier to supply three types of batteries, for example, using a common type of battery holder.

Preferably, adjacent ones of the plurality of spaced apart tongues are spaced apart by a distance less than or equal to the width of the longitudinal inner passage, as defined by the opposed minor faces of the sleeve. Such an arrangement ensures that there is a spaced apart tongue suitably positioned to hold each battery against the opposed major face. Advantageously spaced apart tongues are spaced apart by a distance equal to the width of the longitudinal inner passage, as defined by opposed minor faces of the sleeve, for the width of the passage will normally be equal to the diameter of a battery received in the passage and thus the tongues may then be positioned so that they are each centred on a respective battery.

Each of the plurality of spaced apart tongues advantageously projects into the longitudinal passage in a direction extending toward the second end, to permit batteries inserted from the first end to pass by each tongue, by urging each respective tongue towards, or into, the major face from which it projects.

Advantageously each tongue exerts a pressure on any battery having a thickness in the range of thicknesses sufficient not only to hold a battery against the opposed major face, but to also to retain the battery in place in the longitudinal direction as a result of an applied pressure generating frictional forces.

In accordance with either the first or second aspects of the invention, a battery holder may have an internal spacing between the opposed faces of the first and second pairs of opposed faces which, in use, maintains batteries of a maximum size the holder is intended to accommodate, within the sleeve in a single linear array and prevents the batteries from riding over each other within the sleeve. In this manner, if a battery of the maximum size the holder is intended to accommodate is inserted within the sleeve then the internal spacing between the opposed faces of the first and second pairs of opposed faces can act to directly sandwich the batteries there between and to hold them in place in a linear array.

Several embodiments of the present invention will now be described, by way of example only, with reference to the accompanying drawings, of which:

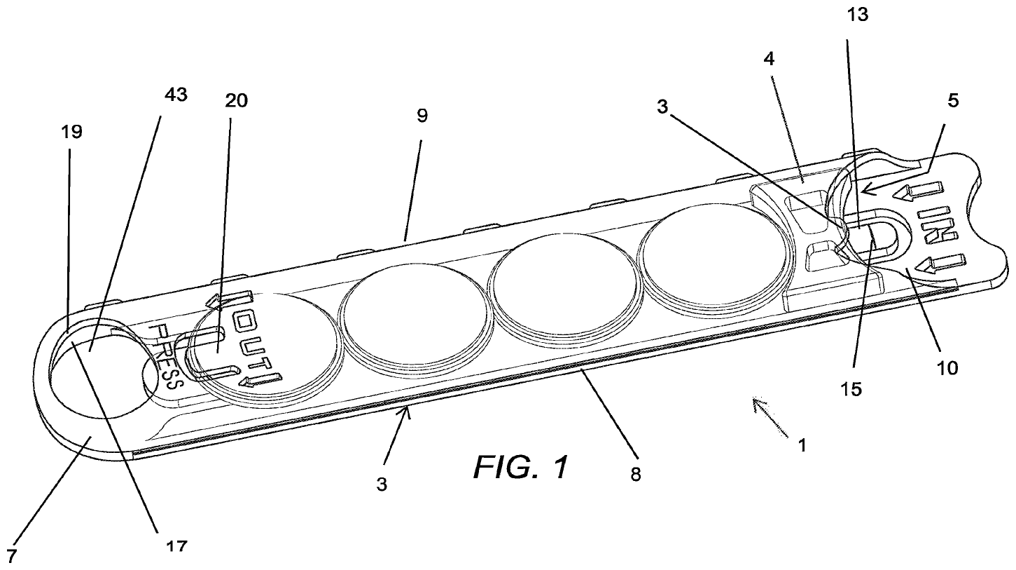

FIG. 1 is a perspective view of a button battery holder in accordance with a first aspect of the present invention, with four button batteries installed;

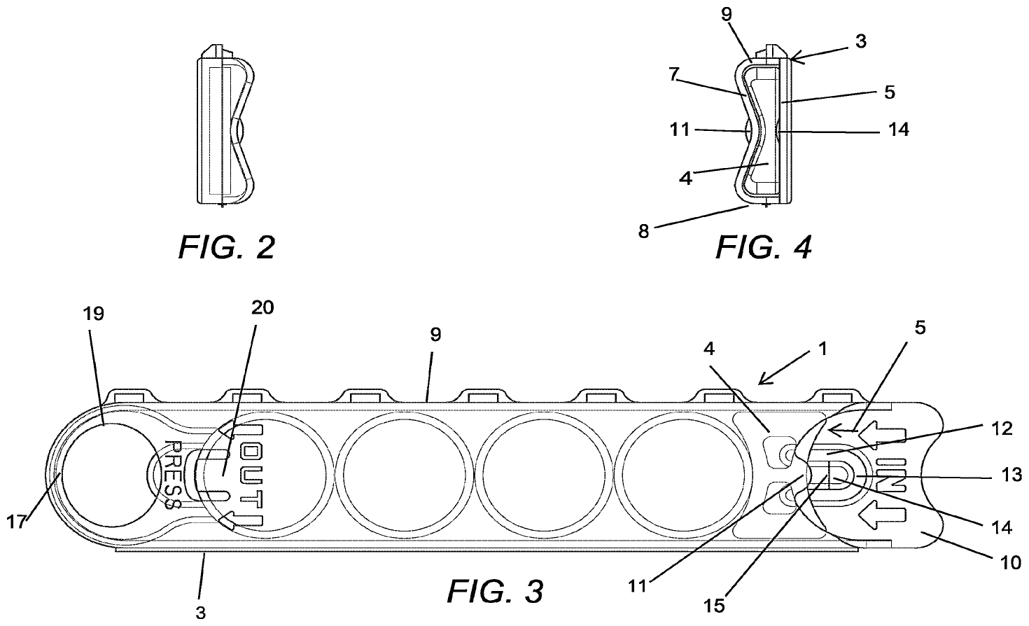

FIG. 2 is a front elevation of the battery holder of FIG. 1;

FIG. 3 is a top view of the battery holder of FIGS. 1 and 2;

FIG. 4 is a rear elevation of the battery holder of FIGS. 1 to 3;

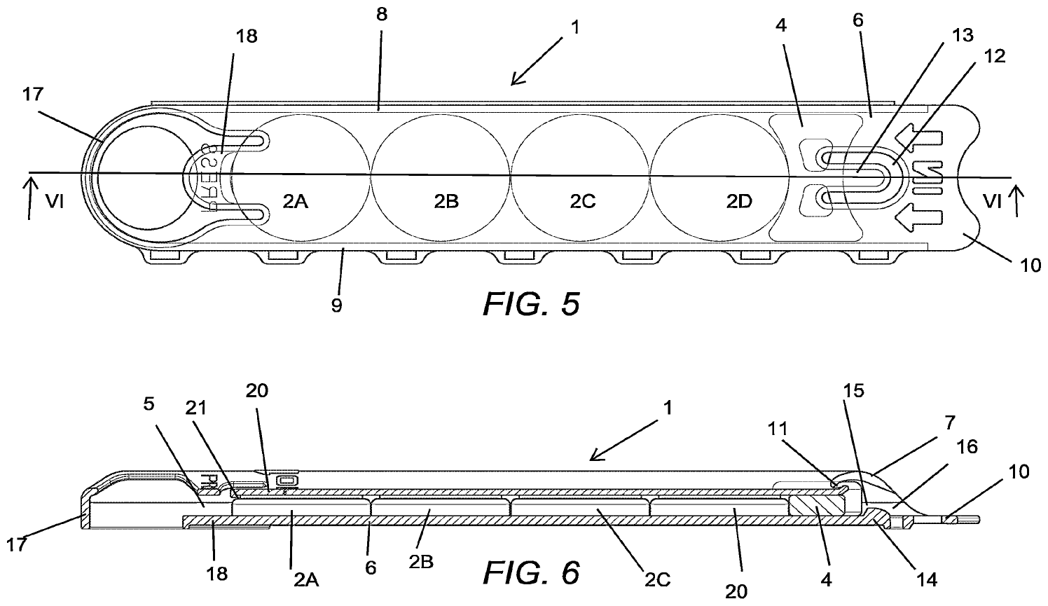

FIG. 5 is a bottom view of the battery holder of FIGS. 1 to 4;

FIG. 6 is a cross section along the line VI-VI of FIG. 5;

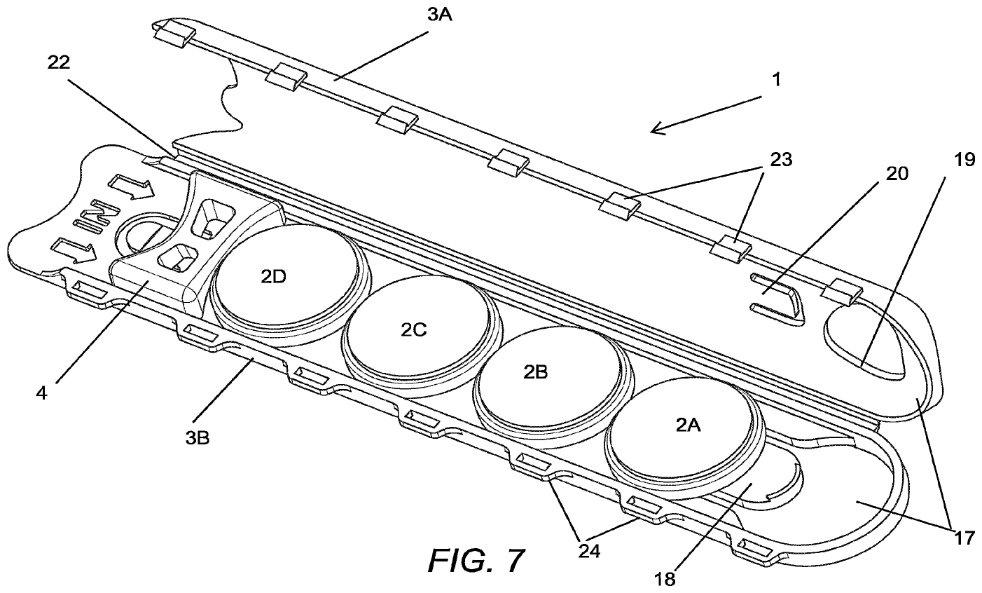

FIG. 7 is a perspective view of the battery holder of FIGS. 1 to 6, showing the separator and batteries in the case prior to the case being closed;

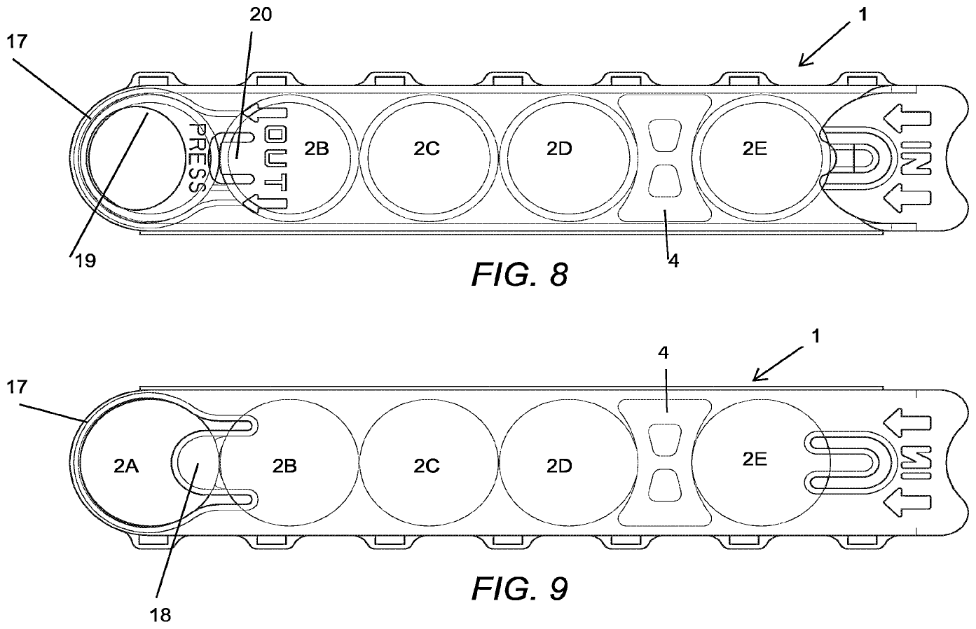

FIG. 8 is a top view corresponding to that of FIG. 3, but with a spent battery inserted;

FIG. 9 is a bottom view of the battery holder of FIG. 8;

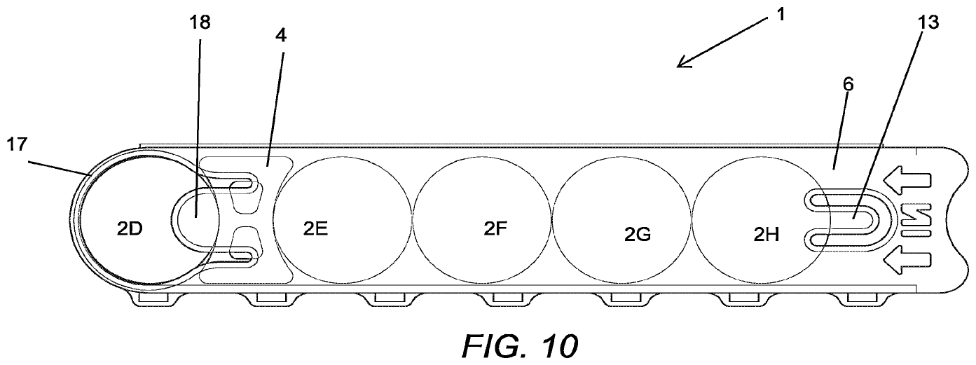

FIG. 10 is a bottom view corresponding to that of FIG. 9, but with four spent batteries inserted into the battery holder;

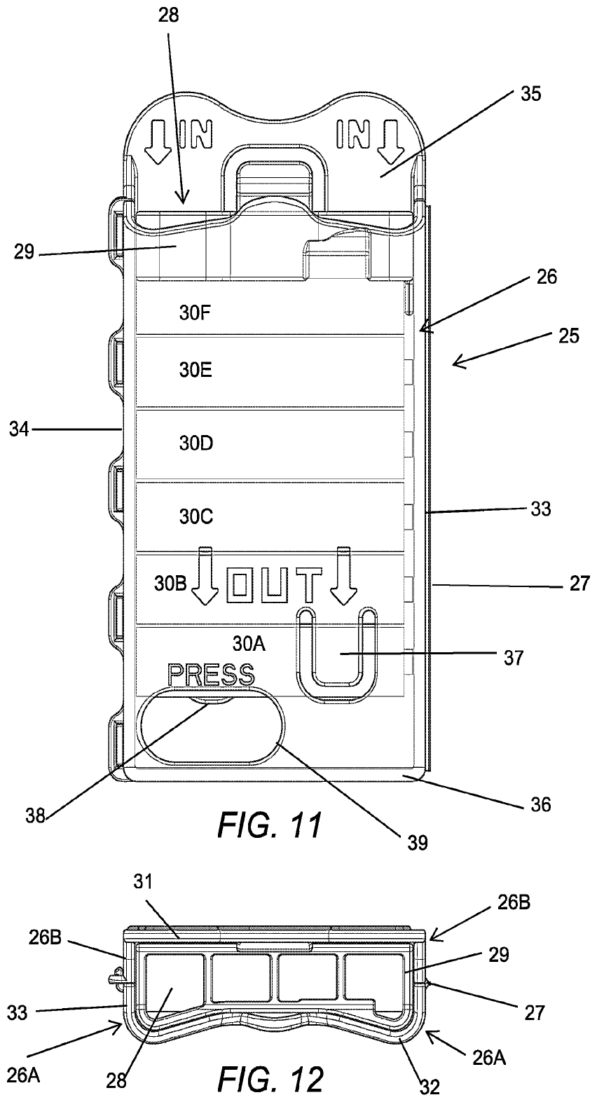

FIG. 11 is a top perspective view of a second embodiment of a battery holder in accordance with the present invention, with six new cylindrical batteries inserted;

FIG. 12 is a rear elevation of the battery holder of FIG. 11;

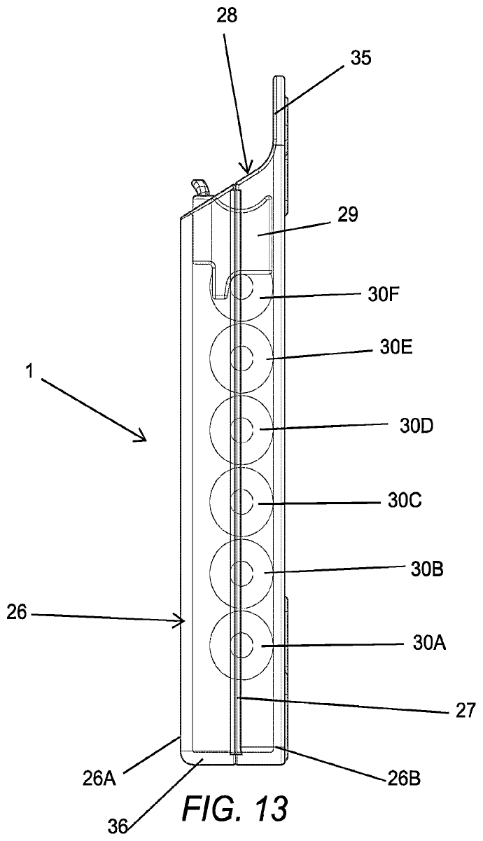

FIG. 13 is a side elevation of the battery holder of FIGS. 11 and 12;

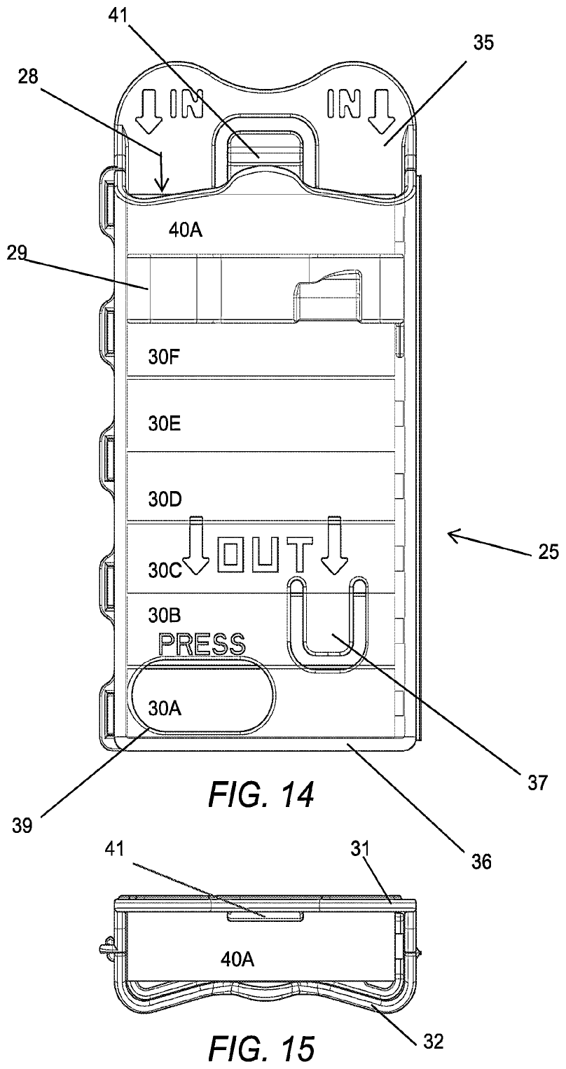

FIGS. 14 and 15 correspond to FIGS. 11 and 12 respectively, but with a spent battery inserted into the battery holder 1;

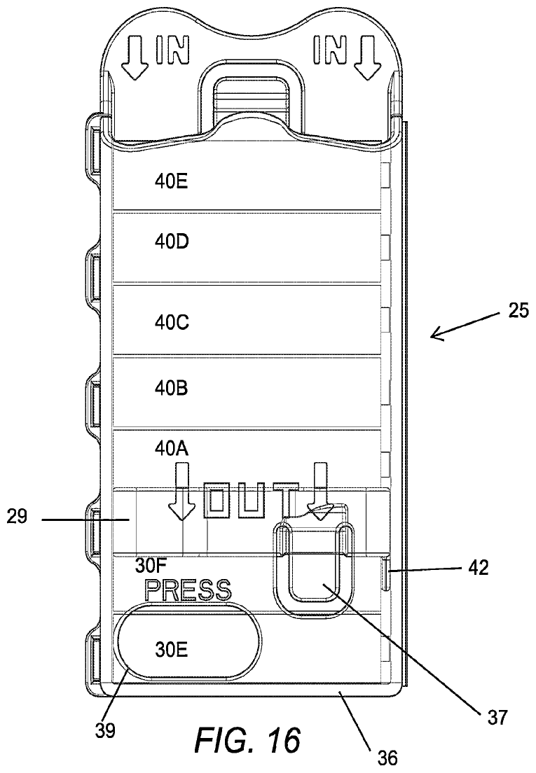

FIG. 16 corresponds to FIGS. 11 and 14, but with five spent batteries inserted into the battery holder 1;

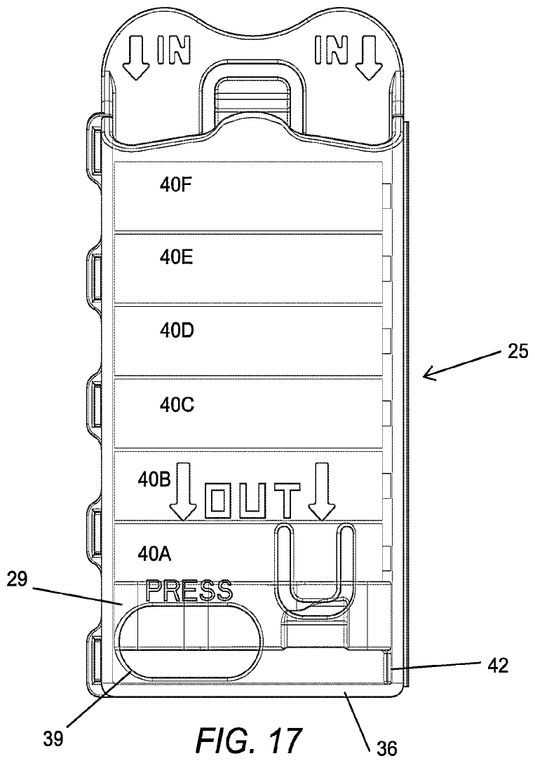

FIG. 17 corresponds to FIGS. 11, 14 and 16, but with six spent batteries inserted into the battery holder;

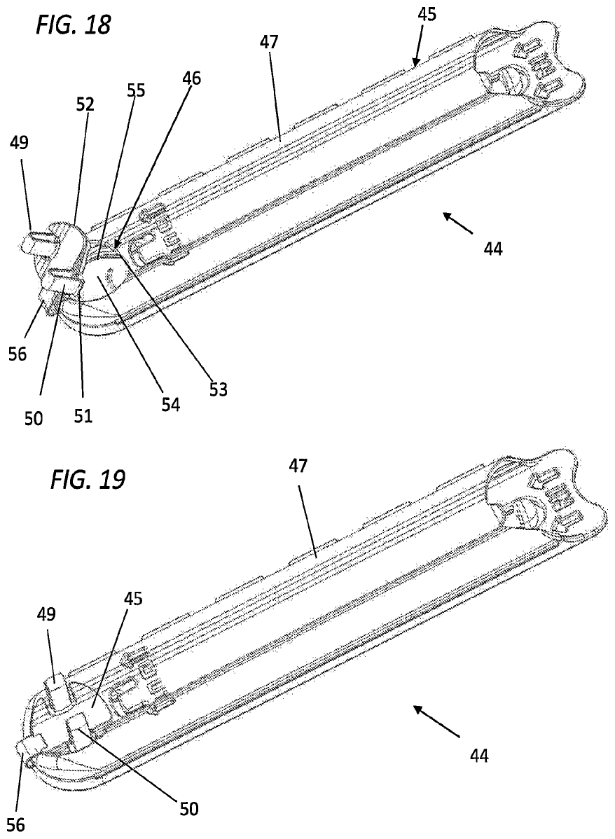

FIG. 18 is a perspective view of an alternative embodiment of a battery holder in accordance with the first aspect of the present invention, with a two clip cover for the second opening shown in an open position;

FIG. 19 corresponds to FIG. 18, but shows the two clip cover in a closed position;

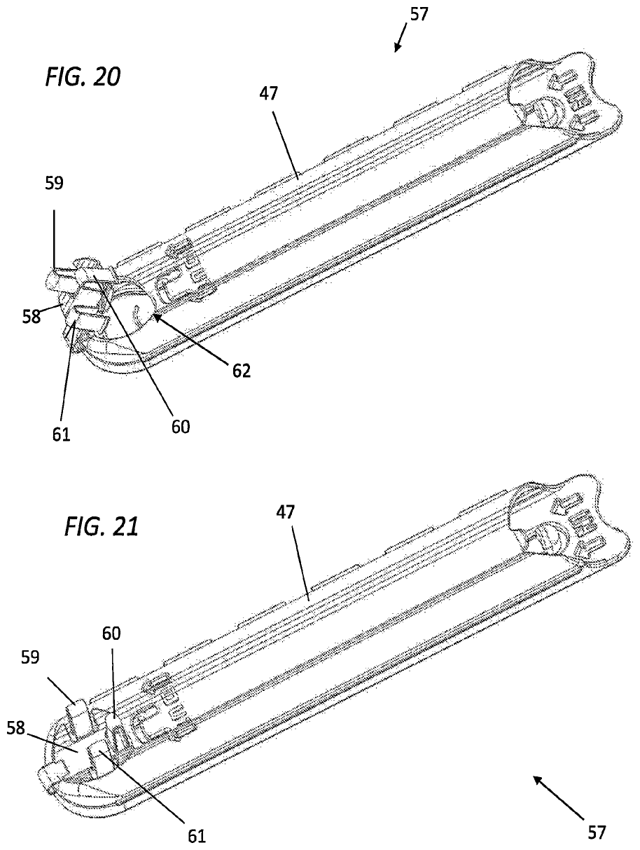

FIG. 20 corresponds to FIG. 18, but with a three clip cover shown in the open position;

FIG. 21 corresponds to FIG. 20, but the three clip cover in a closed position;

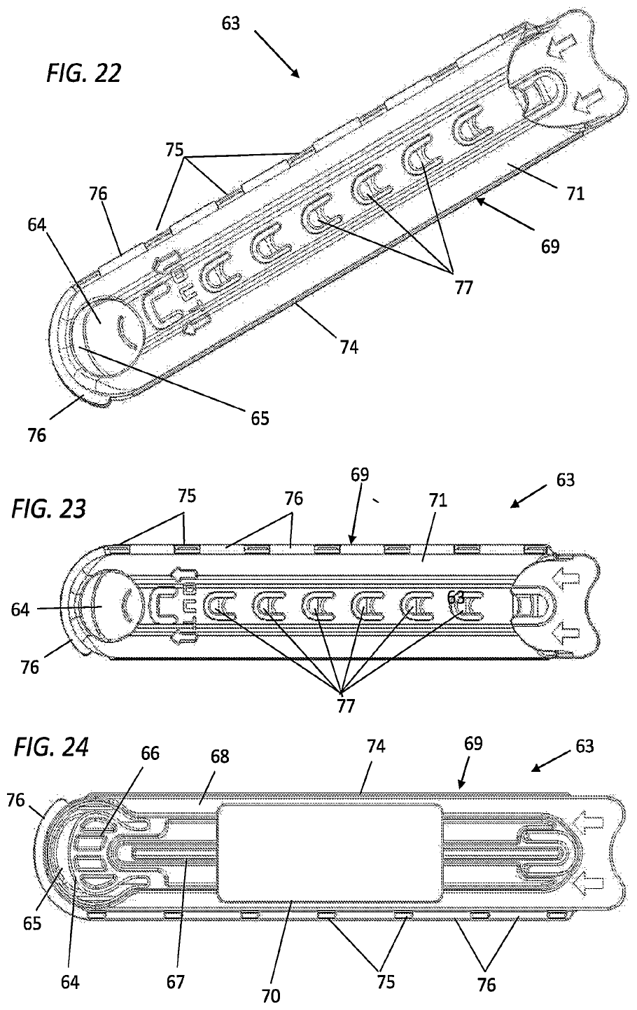

FIG. 22 is a perspective view of a third embodiment of a battery holder in accordance with the first aspect of the present invention;

FIG. 23 is a top view of the battery holder of FIG. 1;

FIG. 24 is a bottom view of the battery holder of FIGS. 22 and 23;

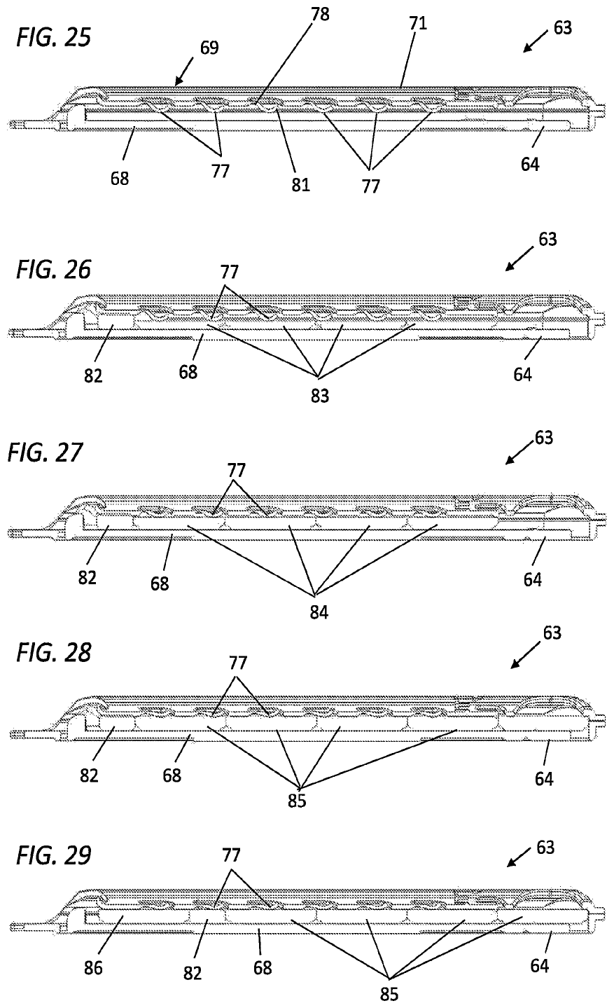

FIGS. 25 to 29 are longitudinal cross-sections of the battery holder shown in FIGS. 22 to 24, showing respectively various different arrangements of batteries within the battery holder;

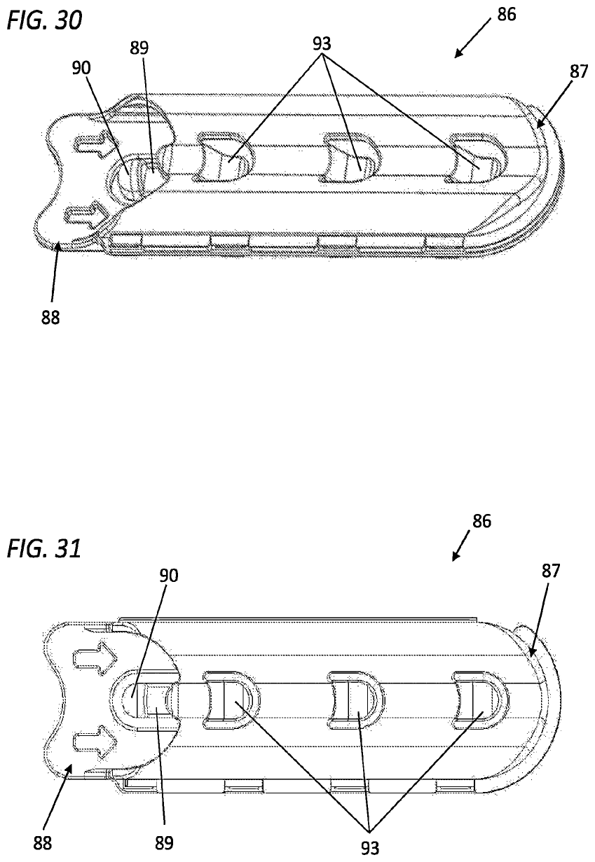

FIG. 30 is a perspective view of a battery holder in accordance with a second aspect of the present invention;

FIG. 31 is a top view of the battery holder of FIG. 30;

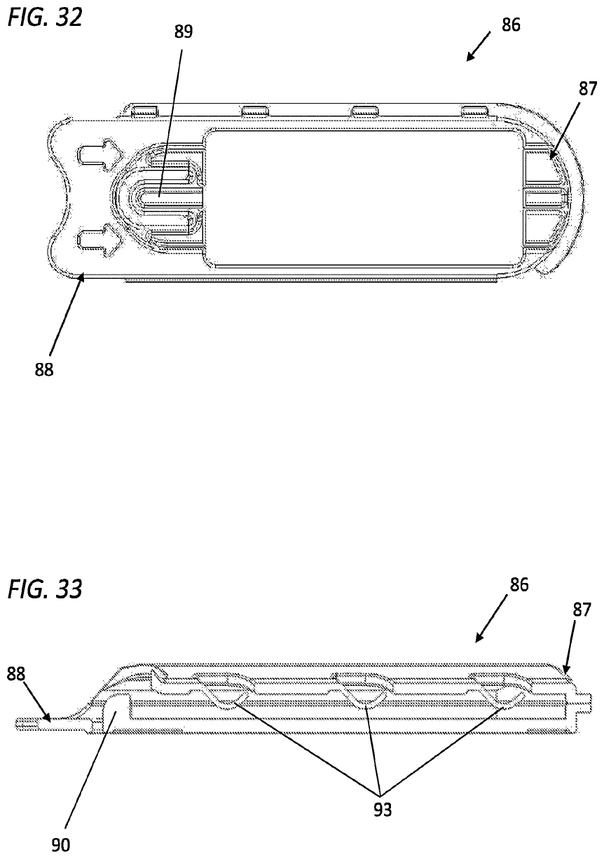

FIG. 32 is a bottom view of the battery holders of FIGS. 30 and 31;

FIG. 33 is a longitudinal cross-section of the battery holder of FIGS. 30 to 32;

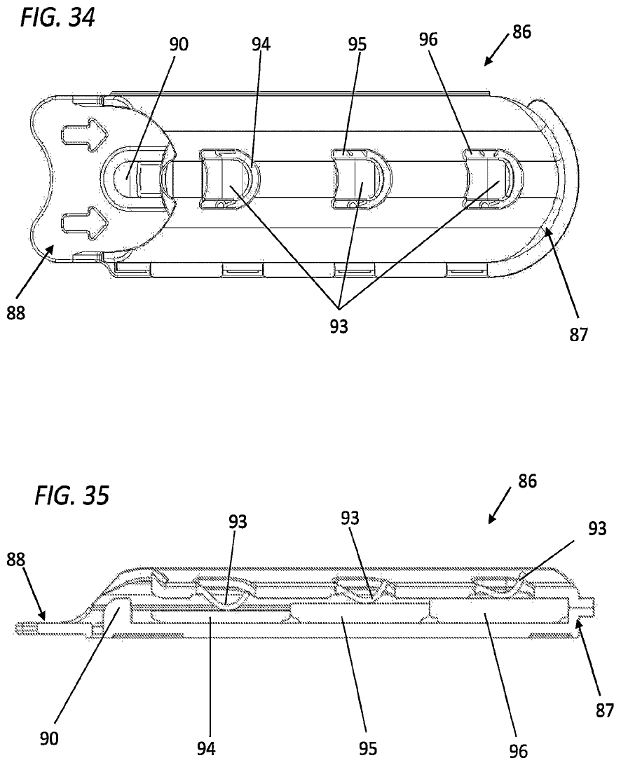

FIG. 34 corresponds to FIG. 32, but shows three batteries inserted in the battery holder; and

FIG. 35 corresponds to the longitudinal cross-section of FIG. 33, but shows three batteries inserted into the battery holder.

Referring now to FIGS. 1 to 10, these disclose a first embodiment of a battery holder, indicated generally as 1, in accordance with a first aspect of the present invention. The battery holder 1, in this embodiment, is for the storage of four button batteries (or button cells) 2A to 2D and in the embodiment illustrated these are type 2032 button batteries, which have a relatively low profile as shown. The battery holder 1 is dimensioned specifically for storage of type 2032 button batteries and advantageously the battery holder will form part of the packaging the button batteries 2A to 2D are sold in.

Although one embodiment of a button battery holder will now be described for storing type 2032 batteries, similar battery holders may be dimensioned to accommodate button batteries of various types or sizes. In addition, although in the illustrated embodiment the battery holder stores four button batteries 2A to 2D, it will be appreciated that such a battery holder may be dimensioned to store any number of button batteries, including one battery.

In the embodiment illustrated in FIGS. 1 to 10, the battery holder comprises a case 3 formed of a clear injection moulded plastic, permitting the button batteries 2A to 2D to be seen through the plastic together with a separator 4, also housed within the case 3.

As will be appreciated from a review of FIGS. 1 to 10, the case 3 has a sleeve portion defining a longitudinal passage 5 in which the button batteries 2A to 2D and the separator 4 are contained, in the manner the batteries would be packaged and purchased.

As most clearly seen from FIG. 4, the passage 5 is defined by the inner surfaces of a bottom face 6, top face 7, left face 8 and right face 9 of the case 3. The top face 7 is convex with a central portion that bears down on the button batteries 2A to 2D, holding them firmly against the bottom face 6, with the resilience of the plastic urging the central portion of the top face 6 into contact with the button batteries 2A to 2D. The cross section of the passage 5, along the length of the sleeve portion of the case 3, thus has a profile as shown in FIG. 4, where the depth of the passage 5 is greater towards the left and right faces 8 and 9 than it is in a central portion. The separator 4, as can be seen from FIG. 4, has a similar cross-sectional profile and this acts to retain the separator 4 in an orientation extending perpendicularly to a longitudinal axis of the passage 5. The separator 4 also has concave leading and trailing edges, which abut respective ones of the button batteries within the battery holder 1, which acts to both centralise the batteries and the separator 4 within the passage 5.

To the rear of the battery holder 1, (right hand side as viewed in FIGS. 1 and 3 and 5 to 6), the top face 7 is cutaway so that the bottom face 6 extends further than the top face and forms a platform 10, bearing the marking “IN” between two arrows. The platform 10 is arranged to receive a battery, which battery, when placed on the platform 10 may be correctly aligned to slide into the passage 5, by being pushed from right to left, as shown in FIG. 3, which may conveniently be achieved by use of a user's thumb. The battery will be guided under the lower central portion of the top face 7 by guide 11, most clearly seen in FIG. 6, which slopes upwards from the central portion of the top face 7 whilst depressing protrusion 14.

As can perhaps be most clearly seen from FIGS. 5 and 6, the bottom face 6, forming the platform 10 has a U-shaped slot 12 formed through it, which slot defines a first integral tongue 13. As can be seen from FIG. 6, the tongue 13 terminates in protrusion 14, which is urged by the tongue 13 into the passage 5. The protrusion forms a stop face 15, arranged to engage with either a battery or the separator 4, to prevent either from exiting the passage 5. The protrusion 14 is resiliently biased to the position shown in FIG. 6 by the tongue 13. Thus, a battery placed on the platform portion 10 may be pushed into the passage 5, with the battery engaging with the chamfered leading edge 16 of the protrusion 14, causing the protrusion to be deflected by the battery, until the battery has passed.

At the front end of the battery holder 1, to the left as shown in FIGS. 1, 3, 5 and 6, the left and right faces 8 and 9, as can best be seen from FIG. 5, curve inwardly to form a curved barrier portion 17 which, as can be seen from FIG. 6, lies across the longitudinal axis of the passage 5. Thus, any battery, such as button battery 2A, sliding along the passage 5, will encounter the barrier portion 17, preventing the battery 2A moving further to the left, as shown in FIG. 6, as will be described below with reference to FIGS. 7 to 10.

As shown in FIG. 5, the bottom face 6, towards the front end of the passage 5, terminates in a tongue 18 which is integrally formed with the bottom face 6. As will be appreciated from FIGS. 5 and 6, when battery 2A is displaced to a holding space where it abuts the barrier portion 17, the tongue 18 will retain the battery 2A within the holding space, as described below with reference to FIGS. 8 to 10. The battery 2A may then be pressed downwards, out of the holding space, by insertion of a finger or thumb through aperture 19, located to the front of the top face 7 of the case 3. This causes the battery 2A to be displaced so that a front end of the battery then protrudes below the level of the bottom face 6 of the holder 1, enabling the battery 2A to then be simultaneously pulled out of the battery holder by the finger and thumb of a user's other hand, whilst pressure continues to be exerted on the battery through the aperture 19, for otherwise the tongue 18 returns the battery 2A back to the holding space where it is no longer assessable. Alternatively, the holder 1 could be arranged to permit the battery to be pushed, in one movement, completely out of the battery holder 1.

As also can be seen from FIG. 1, a further tongue 20 is formed in the top face 7, which as can be seen in FIG. 6, has a protrusion 21 extending down from a front edge. The protrusion 21 engages with a front edge of battery 2A, acting to retain the battery 2A and the batteries behind the battery 2A within the passage 5. However, the protrusion 21 has a chamfered edge towards the battery 2A, permitting the battery to be pushed past the protrusion 21, against the resilience of the tongue 20.

The above-mentioned features, particularly the barrier portion 17 and various protrusions and tongues, preclude the case 3 being manufactured by an extrusion process, unless subsequent steps are performed to produce the aforementioned features. Therefore, the battery holder in this embodiment, as can be seen from FIG. 7, is formed from an injection moulded case 3 comprising a top portion 3A and a bottom portion 3B, joined together by a living hinge 22. On the right-hand edges of both the top portion 3A and bottom portion 3B are located a series of respective ones 23, 24 of cooperating pairs of snap fit non-return clips. Once the batteries 2A to 2D and the separator 4 have been inserted, as shown in FIG. 7, the top portion 3A of the case 3 is closed and fastened to the bottom portion 3B by the none return clips 23, 24. Alternatively, the batteries 2A to 2D and separator 4 could be inserted after closing the top position 3A and bottom portion 3B.

Referring now to FIGS. 8 to 10, these show the battery holder 1 of FIGS. 1 to 6 in use. The battery holder 1 will initially be supplied with four batteries 2A to 2D in it, in the positions indicated in FIGS. 1 to 7. When it is desired to remove a new battery 2A from the battery holder 1, a spent battery 2E will be placed on the platform portion 10 from where it will be pushed into the passage 5 to the position shown in FIGS. 8 and 9, in turn pushing the battery 2A at the other end of the holder, past the protrusion 21 on tongue 20 and into contact with the barrier portion 17. Here it will be held by tongue 18 in a holding space at the very front of the battery holder 1. From this position, the battery 2A may then be pressed downwards, by a person pressing their thumb or finger through the aperture 19, most clearly seen in FIG. 1. This will cause the battery 2A to be displaced at an angle so that a front end of the battery then protrudes below the level of the bottom face 6 of the holder 1, enabling the battery 2A to then be pulled out of the battery holder by the finger and thumb of the user's other hand. Alternatively, the holder 1 could be arranged to permit the battery to be pushed, in one movement, completely out of the battery holder 1.

As each battery 2A to 2D is dispensed from the battery holder 1, the separator 4 will move towards the front of the battery holder. The separator 4 may be brightly coloured and the case 3 moulded from a transparent or translucent plastic, enabling the separator and batteries to be seen through the case and to thus clearly indicate to the user how many new batteries remain in front of the separator. When four spent batteries 2E to 2H have been inserted into the battery holder 1 the separator 4 will adopt the position shown in FIG. 10, where the last new battery 2D to be dispensed is now in the holding space. The battery 2D may thus be dispensed by pressing it out of the battery holder 1 in the manner previously described, at which point the battery holder 1 with the four batteries 2E to 2H in it, in the position shown in FIG. 10, may be disposed of in its entirety for recycling. However, if it is attempted to insert a further spent battery, not shown, or other item, this will cause the separator 4 to be pushed to a position where the front most edges of the separator 4 engage with the inwardly curving left and right faces, so that the separator 4 will wedge halfway across the holding space, preventing any access to the passage 5 via the holding space.

Once the spent batteries have been inserted in the holder they cannot thus then be removed and will be retained safely and not stacked upon each other, which could create a potential risk of fire due to the higher sum voltage.

The invention has so far been described with reference to a battery holder for button cells. However, the invention is equally applicable to battery holders for cylindrical batteries, for example AAA or AA batteries and a second embodiment of a battery holder, in accordance with the present invention, will now be described with reference to FIGS. 11 to 17, which show, in this example, a battery holder 25 dimensioned to store AAA batteries.

Referring first to FIGS. 11 to 13, these show a battery holder, indicated generally as 25, comprising a case 26 which again comprises a top portion 26A and a bottom portion 26B joined together by a living hinge 27 and engaging means, as with the previous embodiment, to form a longitudinal passage 28 in which is located a separator 29 and six new AAA batteries 30A to 30F. The passage 28, as in the previous embodiment, is defined by the internal surfaces of bottom 31, top 32, left 33 and right 34 faces, with the top face 32 being concave and being urged by the resilient nature of the plastics material from which it is formed into contact with the batteries 30A to 30F and the separator 29, to sandwich the batteries 30A to 30F and the separator 29 between the top and bottom faces 32 and 31, to frictionally engage with them. As with the previous embodiment, the bottom face 31 extends further than the top face 32, to form a platform 35 on which a battery may be rested prior to being pushed into the passage 28. At the opposite end of the passage 28, at the front of the battery holder 25, there is a barrier portion 36, which defines a holding space for a battery extending back to a protrusion (not shown) extending inwardly from the end of the tongue 37, as in the previous embodiment, and which retains battery 30A, of FIG. 11, in place. The tongue 37 is resiliently biased inwardly into the passage to restrain battery 30A and subsequent batteries 30B to 30F. However, on insertion of an additional spent battery, the battery 30A will be pushed past the tongue 37 into the holding space forward of the tongue 37, where it is restrained by the barrier portion 36.

As with the previously described embodiment, a thumb or finger may be pushed through aperture 39 in the top face 32 to then press the battery 30A past a tongue 38, partly extending across a slot (not shown) extending partway across the bottom face 31 and wide enough to permit the battery 30A to pass through the slot and out of the battery holder 25.

Referring now to FIG. 14, this shows the battery holder 25 with a first spent battery 40A having been inserted, resulting in battery 30A being moved from the position shown in FIG. 11 to the holding space shown in FIG. 14. Here the battery 30A may then be pressed out of the battery holder 25 past the tongue 38, seen in FIG. 11. The process may then be repeated, with the separator 29 progressively moving along the passage 28, to the position shown in FIG. 16 and on until the last new battery has been dispensed and the separator reaches the final position shown in FIG. 17. Here, an extension portion 42 of the separator 29 contacts the barrier portion 36 of the case 26, preventing the separator 29 moving past the point shown in FIG. 17 and thus trapping the separator and effectively sealing the second end of the passage 28.

From the above description of FIGS. 11 to 17, it will be appreciated that the battery holder of the second embodiment functions in the same manner as the battery holder of the first embodiment and provides the same advantages.

Referring now to FIGS. 18 to 20, here there is illustrated a battery holder, indicated generally as 44, which is essentially the same as the battery holder previously described with reference to FIGS. 1 to 10. However, in the embodiment shown in FIGS. 18 to 19, an additional cover 45 is provided and this clips into and covers aperture 46 in the top portion 47 of the case 48, of the battery holder 44.

The cover 45 comprises two integrally molded clips 49 and 50, the distal ends 51 of which (only one can be seen in FIG. 19) engage under the rim of the aperture 46. The cover 45 has a peripheral rim 52 which engages with a step 53 formed on the edge of the aperture 46, such that the distal ends of the clips 51 and the peripheral rim 52 of the cover sandwich the step 53 and retain the cover 45 in place, in the position shown in FIG. 19.

In order to release the cover 45, the two clips 49 and 50 must both be pressed simultaneously in an inward direction, permitting the cover 45 to then be opened to the position shown in FIG. 18. This then permits a user to press down on any battery retained in the holding space, against the tongue 54 extending across a second aperture 55, in order to expose the battery and permit the battery to then be removed from the holder 44.

The lid 45, in the open position shown in FIG. 18, remains attached to the case 48 by a living hinge 56, thus preventing the cover 45 separating from the case and itself, potentially, becoming a small item that could be swallowed.

The requirement to simultaneously press two clips together is difficult for a baby or small child to achieve. Thus the provision of the cover 45, with the two clips 49 and 50, further enhances the security of the battery holder 44 in preventing batteries being removed by a small child.

In addition to the feature of the cover 45, in the embodiment of FIGS. 18 and 19 the tongue 54 is seen to be larger than the tongue 18 in the embodiment illustrated in FIGS. 1 to 10. As can be seen from FIG. 18, the tongue 54 now almost fills the second aperture 55 and thus substantially shields any battery in the holding space from view. Additionally, with the larger tongue 54, once the cover 45 has been removed, the battery not only has to be depressed downwards out of the holding space, but it must also be simultaneously slid forward out over the front edge of the tongue 54, prior to it being possible to then engage the battery from below between thumb and forefinger and removing it. This again makes it far more difficult for a baby or small child to remove a battery from the holding space.

Referring now to FIGS. 20 and 21 these illustrate a further embodiment of a battery holder identical to the battery holder of FIGS. 18 and 19, except that in this embodiment the cover 58 of the battery holder 57 has three clips 59, 60 and 61, which must be all pressed simultaneously to release the cover 58 from the first aperture 62. This makes it even more difficult for a child to release the cover 58. However, the clips of both these embodiments are provided by way of example only and an alternative may be provided for retaining the cover 58 in, or over, the first aperture 62.

In addition to the above, the covers 45 and 58 of FIGS. 18 to 21 may initially be weakly bonded by adhesive, heat welding or by being mechanically formed integrally with the top portion 47, to thereby provide a tamper evident seal prior to the cover 45, 58 first being released for the first time. This provides the advantage that batteries within the battery holder, prefilled by the manufacturer, cannot be removed from the battery holder 44, 57, or substituted, without the tamper evident seal first being broken.

Referring now to FIGS. 22 to 25, here there is illustrated another embodiment of a battery holder in accordance with the first aspect of the present invention. Except for the points discussed below, this embodiment is the same as the embodiment illustrated in FIGS. 1 to 10 and functions in the same manner.

FIGS. 22 to 25 show a battery holder 63 for holding four batteries, as per the embodiment of FIGS. 1 to 10, but the battery holder could again be modified to hold some other number of batteries.

In the embodiment of FIGS. 22 to 25 the tongue 64 extending across the lower aperture 65 is, as per the embodiment of FIGS. 18 to 20, enlarged relative to the embodiments of FIGS. 1 to 10 and functions and offers the same advantages as the tongue described with reference to FIGS. 18 to 20.

As can be seen from FIGS. 24, the tongue 64 is provided with stiffening ribs 66 permitting the material used to form the tongue to be kept to a minimum. Similarly stiffening ribs 67 are provided over the lower surface of the bottom portion 68 of the case 69, with the exception of a flat area 70, which is provided for the provision of a label.

In the embodiment illustrated in FIGS. 22 to 25, both the bottom portion 68 and the top portion 71 of the case 69 have a peripheral flange which extends along the side opposite to the living hinge 74 and around the front of the case 69, broken only by the snap fit engaging means 75.

During manufacture, once batteries have been inserted into the case 69, the case is initially closed and retained closed by the snap fit engaging means 75. The flanges on the top and bottom portions of the case 69 and the bottom portion of the case are then welded together to create a peripheral flange 76 which, together with the living hinge 74, extends almost continuously around three sides of the case 69, to prevent the case being prised apart on these three sides.

An additional feature present on the embodiments of FIGS. 22 and 25, not seen on the previous embodiments, is the plurality of uniformly spaced apart tongues 77. As can be seen most clearly from FIG. 25, each of the spaced apart tongues 77 extends below the inner surface of the top portion 71 of the case 69. Each spaced apart tongue 77 extends from its proximal end 78, where it is joined to the top portion 71, to a distal free end 81, with each distal free end extending towards the holding space end of the battery holder 63.

As will now be described with reference to FIGS. 26 to 27, when a battery in the form of a button cell, or a separator 82 for dividing new preloaded batteries from inserted spent batteries, passes along the passage defined by the top and bottom portions 71 and 68 of the case, the integrally formed spaced apart tongues 77 are displaced vertically upwards, as shown in FIGS. 26 to 29, permitting the batteries of different thicknesses to be accommodated, while holding those batteries in place against the opposed inner face of the bottom portion 68 of the case 69.

In FIG. 26 the battery holder 63 is shown preloaded with four type 2016 button cells 83, ready for dispensing. These are maintained in a linear array by the spaced apart tongues 77, such that insertion of a spent battery will cause one of the button cells 83 to be displaced to the holding area above tongue 64.

FIG. 27 corresponds to FIG. 26 but shows the battery holder 63 with four type 2025 button cells 84 preinserted.

FIG. 28 also corresponds to FIG. 26 but shows four type 2032 button cells 85 preinserted.

FIG. 29 corresponds to FIG. 28 but shows a depleted type 2032 button cell 86 inserted, with the separator 82 pushed along to the right as shown and one of the new type 2032 button cells 85 displaced into the holding space ready to be pressed out of the battery holder 63, past the tongue 64.

Although not shown, in the embodiment of FIGS. 22 to 29 an additional tongue may be provided on the enlarged lower tongue 64, to urge any battery in the holding space upwards against the lower surface of the top portion 71 of the case, to avoid any battery in the holding space rattling around in the holding space, which could attract the attention of a young child.

The previously describe embodiments disclose battery holders primarily for the dispensing of new batteries, which first require a depleted battery to be returned to the holder in order to for a new battery to be dispensed, with such a battery holder encouraging the safe collection of spent batteries. However, there are many button cell batteries already loose in the environment and button cell batteries are being sold other than in battery holders as described above. Thus there is a requirement for a battery holder to accept spent batteries without dispensing a new battery. The previously described battery holders would provide such a function if supplied empty, without new batteries preinserted. However, there will now described, with reference to FIGS. 30 to 35, a battery holder for receiving spent batteries in accordance with a second aspect of the present invention.

Referring to FIG. 30 a battery holder 86 is of a very similar construction to the embodiment described with reference to FIGS. 22 to 28, except in that in the embodiment of FIGS. 30 to 35 the battery holder is arranged to receive only three batteries in the form of button cells and has a closed second end 87, opposite the first end 88 arranged to receive the spent batteries. The battery holder 86 again has a tongue 89 at the first “receiving” end with an upstanding protrusion 90. The tongue 89 is biased to urge the upstanding protrusion 90 into the passageway defined by the case 91, to prevent any battery inserted from being withdrawn from the first end, as with the previous embodiments. Similarly, the top portion 92 of the case has three spaced apart tongues 93 which, as can be seen FIG. 33, extend downwardly into the passage.

Referring now to FIG. 34, three batteries 94 to 96 are shown inserted in the battery holder 86. As can be seen in FIG. 35, these batteries of three different thicknesses, comprising a type 2016 battery 94, a type 2025 battery 95 and a type 2032 battery 96. The spaced apart tongues 93 retain the three batteries in a linear array, where they abut each so that they are retained in the battery holder as a single layer, avoiding any potential shorting of the batteries and to retain the batteries 94 to 96 inside the battery holder 86 awaiting disposal or recycling.

Several embodiments of the present invention have been described above by way of example only, but it will be appreciated that features from different embodiments may be combined and that other modifications will be apparent to the skilled person, which may fall within the scope of the invention as defined by the following claims. Particularly, some aspects of the invention may be applied to battery holders for very many different shapes and size of battery, such as for example a rectangular 9 Volt batteries. A battery holder could also be curved about an axis parallel to the axis of a battery within the holder and thus could, for example, be horseshoe shaped.

1. A battery holder, comprising a sleeve defining a longitudinal inner passage having a longitudinal axis and having a generally rectangular and generally uniform cross section along its length, wherein:
the sleeve comprises a first major face, or parts thereof, opposed to a second major face and a first minor face opposed to a second minor face, with the respective pairs of opposed faces being arranged to, in use, maintain batteries of a size the holder is intended to accommodate within the sleeve in a single linear array and to prevent the batteries riding over each other within the sleeve;
the sleeve has a first end open to receive a battery;
the sleeve has a second end, opposite to the first end, the second end of the sleeve having a barrier, or partial barrier, across the second end of the sleeve to prevent batteries from being pushed out of the holder in the direction of the longitudinal axis;
the barrier, or partial barrier, together with at least two opposed faces of the sleeve are arranged to retain a battery in a holding space in the sleeve at the second end of the sleeve;
the second end of the sleeve has a first opening dimensioned to permit a battery in the holding space to be pushed therethrough, with a second opening opposed to the first opening, or a region opposed to the first opening, being arranged to permit a user to apply pressure to the battery, in order to push the battery from the holding space so that the battery either extends out of the first opening in the holder, to a position where the battery may be pulled out of the holder, or where the battery is pushed totally out of the battery holder through the first opening.

2. (canceled).

3. A battery holder as claimed in claim 1, wherein at the second end of the sleeve, two opposed faces of the sleeve extend inwardly to form the barrier or partial barrier.

4. A battery holder as claimed in claim 3, wherein the opposed minor faces extend inwardly and join to define a barrier in the form of a closed loop at the second end of the sleeve.

5. A battery holder as claimed in claim 3, wherein the opposed minor faces extend inwardly at the second end to define the first opening and a second opening, the second opening being opposed to the first opening and being arranged to permit a user to apply pressure to a battery in the holding space in order to push the battery from the holding space, so that the battery either extends out of the first opening in the holder, to a position where the battery may be pulled out of the holder, or where the battery is pushed totally out of the battery holder through the first opening.

6. (canceled).

7. A battery holder as claimed in claim 5, further comprising a cover arranged to be retained over, or in, the second opening, to prevent a user from applying pressure to a battery in the holding space and to thus prevent a user pushing the battery from the holding space.

8. A battery holder as claimed in claim 7, further comprising at least two clips arranged to retain the cover in place over, or in, the second opening, wherein the two clips are arranged so that they must be released simultaneously in order to permit the cover to be opened from the second opening.

9. A battery holder as claimed in claim 8, comprising three clips arranged to retain the cover in place over or in the second opening, whereby the three clips are arranged so that they must be released simultaneously, to permit the cover to be opened from the second opening.

10.-12. (canceled).

13. A battery holder as claimed in claim 1, further comprising a tongue extending from the major face adjacent the first opening, partway across the first opening to partly obscure the first opening and thus to retain a battery in the holding space, wherein the tongue may be deflected by pressure applied to the battery, forcing the battery in the holding space against the tongue so that the tongue is displaced, permitting the battery to either extend out of the first opening in the holder, to a position where the battery may be pulled out of the holder, or to be pushed totally out of the battery holder through the first opening.

14. A battery holder as claimed in claim 13, wherein the tongue is dimensioned and arranged to be deflected in a manner to permit the battery to be displaced from the holding space to a position where the battery extends out of the first opening and to a position where the battery may be pulled out of the holder by a user, requiring the user to exert pressure to the battery against the tongue, at the same time as pulling the battery out of the holder through the first opening.

15. A battery holder as claimed in claim 1, wherein the sleeve, in cross section, has one face which is concave and thus has a central portion extending inwardly which is arranged to sandwich batteries of a maximum size that the sleeve is designed to accommodate within the sleeve between the said one face and an opposed face and to frictionally impede passage of the batteries along the passage.

16. A battery holder as claimed in claim 1, further comprising a first protrusion extending into the passage from one of said faces and positioned towards the first end of the sleeve, approximately in line with or slightly outward of the end of the first major face, or parts thereof, so that the first protrusion retains a battery in the passage towards the first end of the sleeve and acts to retain the battery in the passage in a position where the battery is substantially concealed by the major faces of the sleeve, to prevent a person being able to obtain sufficient purchase on the battery to be able to remove the battery from the first end of the sleeve, the first protrusion being sufficiently resilient, or sufficiently resiliently mounted, to permit a battery to be pushed into the sleeve past the first protrusion.

17. A battery holder as claimed in claim 1, further comprising a second protrusion extending into the passage from one of said faces and positioned towards a second end of the sleeve approximately in line with, or forming an edge of, the first opening, so that the second protrusion acts to retain a battery in the passage towards the second end of the sleeve and acts to prevent the battery passing into the holding space, thus acting to retain the battery in the sleeve in a position where the battery cannot be displaced by a finger or thumb pushed into the second opening, the second protrusion being sufficiently resilient, or resiliently mounted, to permit the battery to be pushed along the sleeve into the holding space by an adjacent battery.

18. A battery holder as claimed in claim 16, wherein the first or second protrusion is formed on the end of a tongue formed in one of the faces of the sleeve.

19. A battery holder as claimed in claim 1, further comprising a separator shaped to fit within the passage and pass along the passage between two adjacent batteries.

20. (canceled).

21. A battery holder as claimed in claim 1, arranged to hold at least one button battery, of a specific size, wherein a width of the passage between the two minor faces of the sleeve is approximately equal to a diameter of the button battery and a height of the passage between the two major faces, where the major faces meet the minor faces is approximately equal to a depth of the at least one button battery and wherein the first opening is generally circular and has a diameter approximately equal to the diameter of the at least one button battery.

22. A battery holder as claimed in claim 1, arranged to hold at least one cylindrical battery, of a specific size, wherein a height of the passage between the two major faces of the sleeve, at a point where the major faces of the sleeve meet the minor faces of the sleeve, is approximately equal to a diameter of the at least one cylindrical battery and wherein a width of the passage between the two minor faces is approximately equal to a length of the at least one cylindrical battery.

23.-26. (canceled).

27. A battery holder as claimed in claim 1, arranged for receiving different types of button cell batteries all having one specific diameter, but having one of a range of different thicknesses, wherein the inner passage is dimensioned to accommodate all batteries in the range including those having a maximum thickness within said range of thicknesses, wherein one of the major faces of the sleeve has a plurality of spaced apart tongues, each resiliently biased such that each spaced apart tongue projects into the longitudinal inner passage and acts to retain any battery having a thickness within said range of thicknesses against the opposed major face of the sleeve defining the longitudinal inner passage.

28. (canceled).

29. A battery holder as claimed in claim 27, wherein each of the plurality of spaced apart tongues projects into the longitudinal passage in a direction extending toward the second end, to permit batteries inserted from the first end to pass by the plurality of spaced apart tongues, by a battery urging the respective spaced apart tongue towards, or into, the major face from which the respective spaced apart tongue projects.

30. A battery holder as claimed in claim 27, wherein each spaced apart tongue exerts a pressure on any battery having a thickness in the range of thicknesses and acts not to both hold a battery against the opposed major face and to retain the battery in place in the longitudinal direction due to an applied pressure generating frictional forces.

31.-34. (canceled).

35. A battery holder for receiving and storing spent batteries, the battery holder comprising a sleeve defining a longitudinal inner passage having a longitudinal axis and having a generally rectangular and generally uniform cross section along its length, wherein:
the sleeve comprises a first major face, or parts thereof, opposed to a second major face and a first minor face opposed to a second minor face, with the opposed faces being arranged to, in use, maintain batteries of a size the holder is intended to accommodate within the sleeve in a single linear array and to prevent the batteries riding over each other within the sleeve;
the sleeve has a first end arranged to receive a spent battery;
the sleeve has a second closed end; and
wherein the battery holder further comprises a first protrusion extending into the passage from one of said faces and positioned towards the first end of the sleeve, approximately in line with or slightly outward of the end of the first major face, or parts thereof, so that the first protrusion will retain a battery in the passage towards the first end of the sleeve and acts to retain the battery in the passage in a position where the battery is substantially concealed by the major faces of the sleeve, to prevent a person being able to obtain sufficient purchase on the battery to be able to remove the battery from the first end of the sleeve, the first protrusion being sufficiently resilient, or sufficiently resiliently mounted, to permit a battery to be pushed into the sleeve past the first protrusion.
